(19) United States
(12) Patent Application Publication
(10) Pub. No.: US 2014/0047226 A1
(43) Pub. Date: Feb. 13, 2014

(54) MANAGING HARDWARE CONFIGURATION OF A COMPUTER NODE

(71) Applicant: International Business Machines Corporation, Armonk, NY (US)

(72) Inventors: Shiva R. Dasari, Austin, TX (US); Raghuswamyreddy Gundam, Austin, TX (US); Newton P. Liu, Austin, TX (US); Douglas W. Oliver, Round Rock, TX (US); Terence Rodrigues, Austin, TX (US); Mehul M. Shah, Austin, TX (US); Wingcheung Tam, Austin, TX (US)

(73) Assignee: INTERNATIONAL BUSINESS MACHINES CORPORATION, Armonk, NY (US)

(21) Appl. No.: 14/055,535

(22) Filed: Oct. 16, 2013

Related U.S. Application Data
(63) Continuation of application No. 13/437,504, filed on Apr. 2, 2012.

(51) Int. Cl. G06F 9/44; G06F 1/26

(52) U.S. Cl. CPC G06F 9/4411; G06F 1/266
USPC 713/1

(57) ABSTRACT

A method and computer program product for configuring the hardware devices of a computer node are disclosed. The method comprises the computer node receiving a user identification, and identifying a hardware configuration of the computer node that is stored in association with the user identification, wherein the hardware configuration identifies a subset of the hardware devices within the computer node that are not to receive power. The hardware configuration may be stored in associated with the user identification, for example by an administrator during setup. In one option, the computer node receives the user identification during user logon to the computer node. The method further comprises controlling power to the hardware devices of the computer node to implement the identified hardware configuration without physically removing the subset of hardware devices. Power is provided to the computer node except for the subset of the hardware devices.

### CROSS-REFERENCE TO RELATED APPLICATIONS

This application is a continuation of U.S. patent application Ser. No. 13/437,504 filed on Apr. 2, 2012, which application is incorporated by reference herein.

### BACKGROUND OF THE INVENTION

1. Field of the Invention

The present invention relates to the hardware configuration of an individual computer node.

2. Background of the Related Art

A computer node may be manually configured to include a variety of hardware devices that give the computer node additional capability or performance. For example, additional or higher capacity memory modules, such as dual inline memory modules (DIMMs), may be inserted into a memory slot on a motherboard. Input and output devices may also be provided or facilitated by installing an expansion card into another slot on the motherboard, such as a peripheral connect interface (PCI) slot. Even additional central processing units (CPUs) may be installed if the motherboard has the additional sockets.

Some devices can be manually hot plugged into a computer node without shutting down the computer node. Such devices may include external devices that are connected through a Universal Serial Bus (USB) port. However, many of the hardware devices of a computer node can only be manually added or removed from a computer node while the computer node is powered off. For example, physically removing a memory module or CPU while the computer node is running would likely lead to loss of data, the occurrence of numerous errors, and the like. Still, it should be recognized that each of these hardware devices is added or removed through physical handling of the hardware device or its connection.

In computer nodes that run virtual machines, it is possible for a particular virtual machine to be provisioned with limits on access to particular hardware devices. For example, one virtual machine may be prevented from using a particular input/output device, while another virtual machine running on the same computer node may have full access to the input/output device. If fewer virtual machines have access to an input/output device, then the load on that the input/output device may be reduced. However, even if none of the virtual machines have access to the input/output device, that input/output device is still powered on and is consuming some low level of electricity. Furthermore, a virtual machine platform is not available on all computer nodes and does itself consume a certain amount of system resources.

### BRIEF SUMMARY OF THE INVENTION

One embodiment of the present invention provides a method of configuring the hardware devices of a computer node. The method comprises the computer node receiving a user identification, and identifying a hardware configuration of the computer node that is stored in association with the user identification, wherein the hardware configuration identifies a subset of the hardware devices within the computer node that are not to receive power. The method further comprises controlling power to the hardware devices of the computer node to implement the identified configuration of the computer node without physically removing the subset of hardware devices, wherein power is provided to the computer node except for the subset of the hardware devices.

Another embodiment of the invention provides a computer program product including computer usable program code embodied on a computer usable storage medium for configuring the hardware devices of a computer node. The computer program product includes computer usable program code for storing a hardware configuration of the computer node in associated with a user identification, computer usable program code for receiving a user identification during user logon, and computer usable program code for identifying a hardware configuration of the computer node that is stored in association with the user identification, wherein the hardware configuration identifies a subset of the hardware devices that are not to receive power. The computer program product further includes computer usable program code for controlling power to the hardware devices of the computer node to implement the identified configuration of the computer node without physically removing the subset of hardware devices, wherein power is provided to the computer node except for the subset of the hardware devices.

### BRIEF DESCRIPTION OF THE SEVERAL VIEWS OF THE DRAWINGS

FIG. 1 is a block diagram of one embodiment of a computer node that may be utilized in accordance with the present invention.

FIG. 2 is a block diagram of a computer node in accordance with one embodiment of the present invention.

FIG. 3 is a flowchart showing one embodiment of a method for configuring the hardware devices of a computer node.

FIG. 4 is a flowchart of a second embodiment of a method 310 for configuring the hardware devices of a computer node.

### DETAILED DESCRIPTION OF THE INVENTION

One embodiment of the invention provides a computer node, comprising a motherboard, an integrated management module, and a field-programmable gate array. The motherboard supports a plurality of individual devices comprising one or more central processing unit and one or more memory module. The integrated management module receives a user identification and identifies a hardware configuration of the computer node associated with the user identification, wherein the hardware configuration identifies one or more of the plurality of individual devices that are to be powered off. The field-programmable gate array is in communication with the integrated management module and in communication with a power switch for each of the plurality of individual devices within the computer node to implement the identified hardware configuration of the computer node. The integrated management module may instruct the field-programmable gate array to power off the one or more of the plurality of individual devices, and wherein powering off the one or more of the plurality of individual devices does not power off the other individual devices of the computer node.

The computer node may, for example, be a single instance of a desktop computer, notebook computer, server or other electronic device that may be useful in multiple hardware configurations. Although the computer node may be networked, the present invention is directed at the configuration of hardware devices within an individual computer node. It should be recognized that the present invention may be used to configure hardware devices within one or more computer nodes that happen to be within a network.

A typical computer node includes a motherboard that supports a plurality of individual hardware devices comprising one or more central processing unit and one or more memory module. The hardware devices may also include one or more input/output devices installed in one or more slots on the motherboard or one or more communications buses.

The computer node further includes an integrated management module (IMM). Although the IMM serves may other functions, in accordance with embodiment of the present invention the IMM receives a user identification and identifies a hardware configuration of the computer node associated with the user identification. The hardware configuration identifies one or more of the plurality of individual devices that are to be powered off. The integrated management module uses the hardware configuration as the basis for instructing a field-programmable gate array (FPGA) to power off the one or more of the plurality of individual devices that are to be powered off. Still, powering off the one or more of the plurality of individual devices does not power off the other individual devices of the computer node.

The field-programmable gate array is in communication with the integrated management module and in communication with a plurality of power switches. One power switch is associate one of the individual devices within the computer node to implement the identified hardware configuration of the computer node. Optionally, the computer node may use an application programming interface that the integrated management module uses to facilitate communication of the hardware configuration to the field-programmable gate array. The field-programmable gate array then controls the power switches that determine whether or not an individual device receives power. In various implementations, the field-programmable gate array may also supply other types of signals that control one or more functions of an individual device, such as a signal that controls the performance of one or more buses, such as a direct media interface bus.

Another embodiment of the present invention provides a method of configuring the hardware devices of a computer node. The method comprises the computer node receiving a user identification, and identifying a hardware configuration of the computer node that is stored in association with the user identification, wherein the hardware configuration identifies a subset of the hardware devices within the computer node that are not to receive power. The hardware configuration may be stored in associated with the user identification, for example by an administrator during setup. Preferably, the hardware configuration of the computer node is stored in nonvolatile memory. In one option, the computer node receives the user identification during user logon to the computer node.

The method further comprises controlling power to the hardware devices of the computer node to implement the identified hardware configuration without physically removing the subset of hardware devices. Power is provided to the computer node generally, but the power may be turned off for the subset of the hardware devices. The power to each of the hardware devices is controlled by a field-programmable gate array.

In one embodiment, an integrated management module within the computer node receives the user identification and identifies a hardware configuration of the computer node associated with the user identification. Preferably, the integrated management module has memory that stores the user identification and the associated hardware configuration. Alternatively, the IMM has access to another memory device, such as flash memory residing between the Southbridge and the IMM off of a low pin count (LPC) interface.

The integrated management module communicates the hardware configuration to the field-programmable gate array, optionally using an application programming interface to facilitate that communication. In one example, the IMM communicates with the FPGA over an inter-integrated circuit (I2C) bus.

In a first example of controlling power, the subset of hardware devices includes one or more central processor units. Accordingly, one embodiment of the method may include allowing failover of one or more central processor units that were powered on to one or more central processor units that have, until failover, been powered off.

In a second example, the subset of hardware devices includes one or more buses, such as a direct media interface bus. Accordingly, one embodiment of the method may include controlling the speed configuration on one or more buses within the computer node.

In a third example, the subset of hardware devices includes one or more slots that support an input/output device. Accordingly, one embodiment of the method includes selectively enabling or disabling the one or more slots, which in turn enables or disables the one or more cards installed in the one or more affected slots.

In a fourth example, the subset of hardware devices includes one or more memory devices selected from individual memory modules, memory controllers, or a combination thereof. Accordingly, one embodiment of the method includes selectively enabling or disabling the one or more memory modules, such as by enabling or disabling the one or more slots where the one or more memory modules are installed.

In a further embodiment of the method, one or more memory device or PCI device is prevented from being powered on during initialization of the computer node to allow the setup to complete in less time. One way to prevent the device from being powered on during initialization of the computer node includes holding one or more PCI device in reset. The FPGA can hold a PCI device in reset by instructing the host firmware to manually disable the device, or by driving a signal on a dedicated reset line to the PCI device. Alternatively, the power to one or more of the particular devices may be powered off using a switch to interrupt the supply of power to the one or more of the particular devices. Optionally, if an additional memory device or PCI device is needed after the initialization has completed, then those one or more additional devices may be powered on after initialization. The FPGA can do this by causing the additional devices, such as CPUs, DIMMs and the like, to be essentially hot powered on.

In another embodiment, the method may further include storing a description of a default hardware configuration of the computer node. The default hardware configuration may be used, for example, when no user identification has been received. Where the computer node receives the user identification during user logon and implements an associated hardware configuration, the method may further include returning the computer node to the default hardware configuration in response to user logoff from the computer node.

Yet another embodiment of the invention provides a computer program product including computer usable program code embodied on a computer usable storage medium for configuring the hardware devices of a computer node. The computer program product includes computer usable program code for storing a hardware configuration of the computer node in associated with a user identification, computer usable program code for receiving a user identification during user logon, and computer usable program code for identifying a hardware configuration of the computer node that is stored in association with the user identification, wherein the hardware configuration identifies a subset of the hardware devices that are not to receive power. The computer program product further includes computer usable program code for controlling power to the hardware devices of the computer node to implement the identified configuration of the computer node without physically removing the subset of hardware devices, wherein power is provided to the computer node except for the subset of the hardware devices. It should be recognized that various aspects of the methods described herein may be implemented in a computer program product by providing appropriate computer usable program code.

In a further embodiment, the computer program product further comprises computer usable program code for preventing one or more memory device or PCI device from being powered on during initialization of the computer node to allow the setup to complete in less time. Optionally, the computer program product may also include computer usable program code for powering on an additional memory device or PCI device after the setup has completed.

In a still further embodiment, the computer program product may further comprise computer usable program code for storing a description of a default hardware configuration of the computer node, and computer usable program code for returning the computer node to the default hardware configuration in response to user logoff from the computer node.

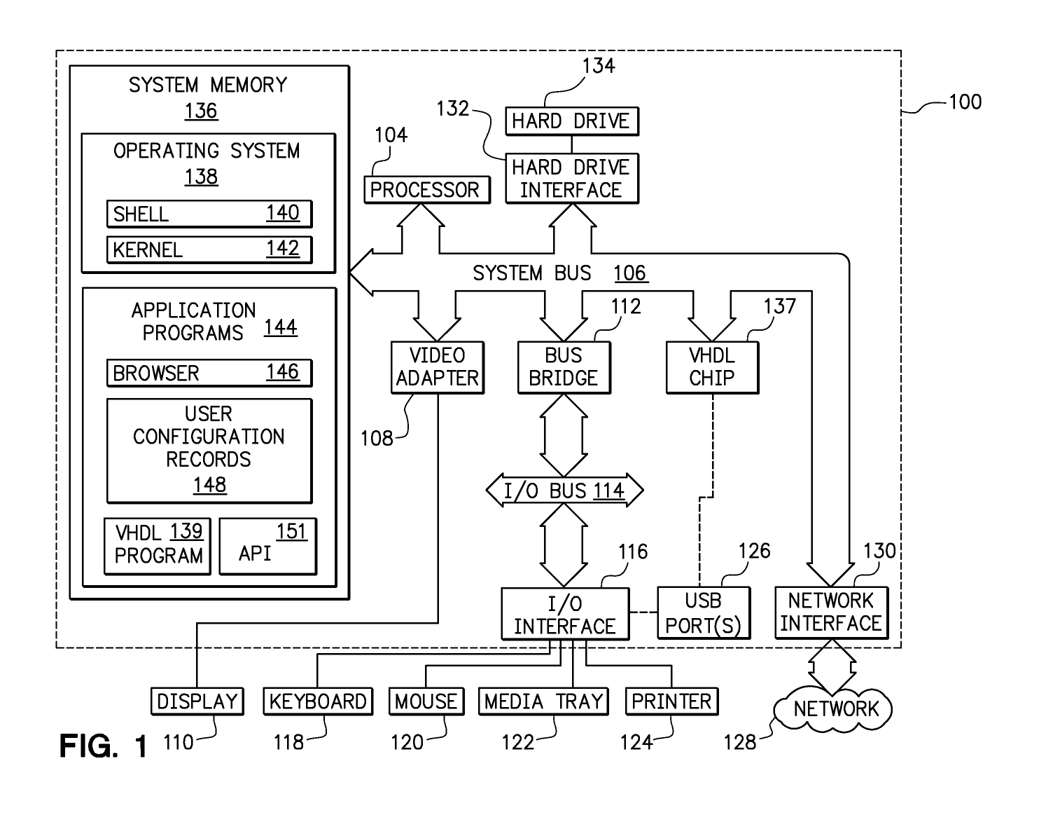

With reference now to the figures, FIG. 1 is a block diagram of an exemplary computer node 102, which may be utilized by the present invention. The computer node described herein may be a stand-alone computer, server, or other integrated or stand-alone computing device.

Computer node 200 includes a processor unit 104 that is coupled to a system bus 106. Processor unit 104 may utilize one or more processors, each of which has one or more processor cores. A video adapter 108, which drives/supports a display 110, is also coupled to system bus 106. System bus 106 is coupled via a bus bridge 112 to an input/output (I/O) bus 114. An I/O interface 116 is coupled to I/O bus 114. I/O interface 116 affords communication with various I/O devices, including a keyboard 118, a mouse 120, a media tray 122 (which may include storage devices such as CD-ROM drives, multi-media interfaces, etc.), a printer 124, and (if a VHDL chip 137 is not utilized in a manner described below) external USB port(s) 126. While the format of the ports connected to I/O interface 116 may be any known to those skilled in the art of computer architecture, in a preferred embodiment some or all of these ports are universal serial bus (USB) ports.

As depicted, the computer node 200 is able to communicate with other computer nodes and devices via network 128 using a network interface 130. The network 128 may be an external network such as the Internet, or an internal network such as an Ethernet or a virtual private network (VPN).

A hard drive interface 132 is also coupled to the system bus 106. The hard drive interface 132 interfaces with a hard drive 134. In a preferred embodiment, the hard drive 134 communicates with system memory 136, which is also coupled to the system bus 106. System memory is defined as a lowest level of volatile memory in the computer 102. This volatile memory includes additional higher levels of volatile memory (not shown), including, but not limited to, cache memory, registers and buffers. Data that populates the system memory 136 includes the operating system (OS) 138 and application programs 144 of the computer node 200.

The operating system 138 includes a shell 140 for providing transparent user access to resources such as application programs 144. Generally, the shell 140 is a program that provides an interpreter and an interface between the user and the operating system. More specifically, the shell 140 executes commands that are entered into a command line user interface or from a file. Thus, the shell 140, also called a command processor, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 142) for processing. Note that while the shell 140 is a text-based, line-oriented user interface, the present invention will equally well support other user interface modes, such as graphical, voice, gestural, etc.

As depicted, the operating system 138 also includes kernel 142, which includes lower levels of functionality for the operating system 138, including providing essential services required by other parts of the operating system 138 and application programs 144, including memory management, process and task management, disk management, and mouse and keyboard management.

The application programs 144 include an optional renderer, shown in exemplary manner as a browser 146. The browser 146 includes program modules and instructions enabling a world wide web (WWW) client (i.e., computer node 102) to send and receive network messages to the Internet using hypertext transfer protocol (HTTP) messaging, thus enabling communication with other computer nodes and systems.

Application programs 144 in the system memory of the computer node 102 also optionally include an application programming interface (API) 151 that is able to communicate with user configuration records 148, which store user identifications and associated hardware configurations, as described below.

Optionally also stored in the system memory 136 is a VHDL (VHSIC hardware description language) program 139. VHDL is an exemplary design-entry language for field programmable gate arrays (FPGAs), application specific integrated circuits (ASICs), and other similar electronic devices. In one embodiment, execution of instructions from the API 151 causes VHDL program 139 to configure VHDL chip 137, which may be an FPGA, ASIC, etc.

The hardware elements depicted in computer node 200 are not intended to be exhaustive, but rather are representative to highlight essential components required by the present invention. For instance, computer node 200 may include alternate memory storage devices such as magnetic cassettes, digital versatile disks (DVDs), Bernoulli cartridges, and the like. These and other variations are intended to be within the spirit and scope of the present invention.

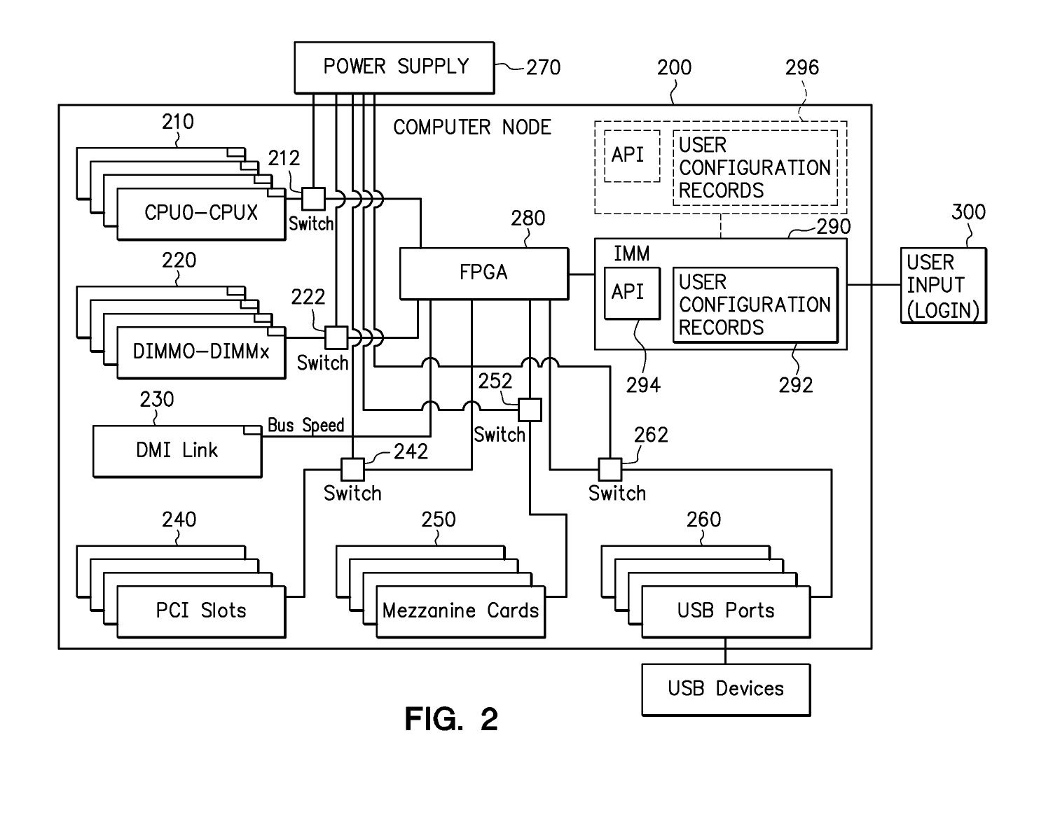

FIG. 2 is a block diagram of a computer node 200 in accordance with one embodiment of the present invention. The computer node 200 may be similar to, or different from, the computer node 100 of FIG. 1, but will typically include many of the same hardware devices. Many of the hardware devices that would be present in computer node 200 have been omitted from FIG. 2 in order to highlight operation of the present invention.

The computer node 200 includes various hardware devices, including one or more CPUs 210, one or more DIMM 220, one or more DMI link 230, one or more PCI slots 240, one or more mezzanine cards 250, and one or more USB ports 260. A power supply 270 provides power for the operation each of the hardware devices in the computer node 200, but whether certain hardware devices receive power at a given point in time depends upon the condition of a switch. For example, each of the CPUs may be coupled to the power supply 270 through its own switch 212. Accordingly, a computer node with four CPUs 210 would have four switches 212 (only one shown in FIG. 2). Each of those four switches 212 would be independently controllable by the FPGA 280 to allow any one or more of the CPUs to be powered off without necessarily also powering off the other CPUs. The FPGA 280 controls other switches in the computer node 200 in order to provide similar control of other hardware devices. Specifically, as shown in FIG. 2, the FPGA 280 communicates with one or more switches 222 to independent control power to one or more DIMM 220, one or more switches 242 providing power to one or more PCI slots 240, one or more switches 252 providing power to one or more mezzanine cards 250, and one or more switches 262 providing power to one or more USB ports 260. The FGA 280 may also control other aspects of the hardware devices, such as controlling the bus speed of the DMI link 230. It should be apparent to those having ordinary skill in the art that other hardware devices may be controlled in the same or similar manner as just described.

In one embodiment, a user 300 provides input to an IMM 290 during a logon process. Accordingly, the IMM 290 receives a user identification and performs a lookup in a table of user configuration records 292. If the user identification is found in the table, the IMM 290 retrieves the hardware configuration that is associated with the user identification. The IMM 290 may use an API 294 in order to communicate the hardware configuration to the FPGA 280. The FPGA 280 then implements the hardware configuration without requiring that the computer node 200 be powered off. In one alternative embodiment, the API and User Configuration Records may be stored in memory 296 that is separate from, but accessible to, the IMM 290. The memory, whether internal or external to the IMM 290, is preferably a nonvolatile memory such as SEEPROM, NVRAM, or flash.

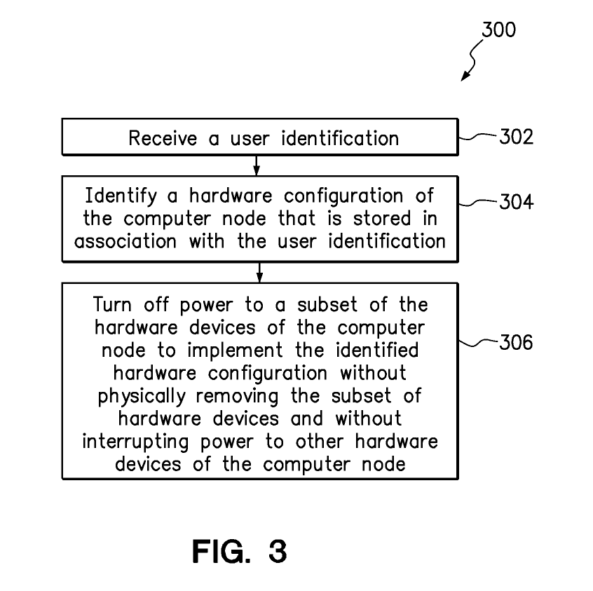

FIG. 3 is a flowchart showing one embodiment of a method 300 for configuring the hardware devices of a computer node. In step 302, the computer node receives a user identification, and in step 304 the computer node identifies a hardware configuration of the computer node that is stored in association with the user identification. In step 306, the method turns off power to a subset of the hardware devices of the computer node to implement the identified hardware configuration without physically removing the subset of hardware devices and without interrupting power to other hardware devices of the computer node

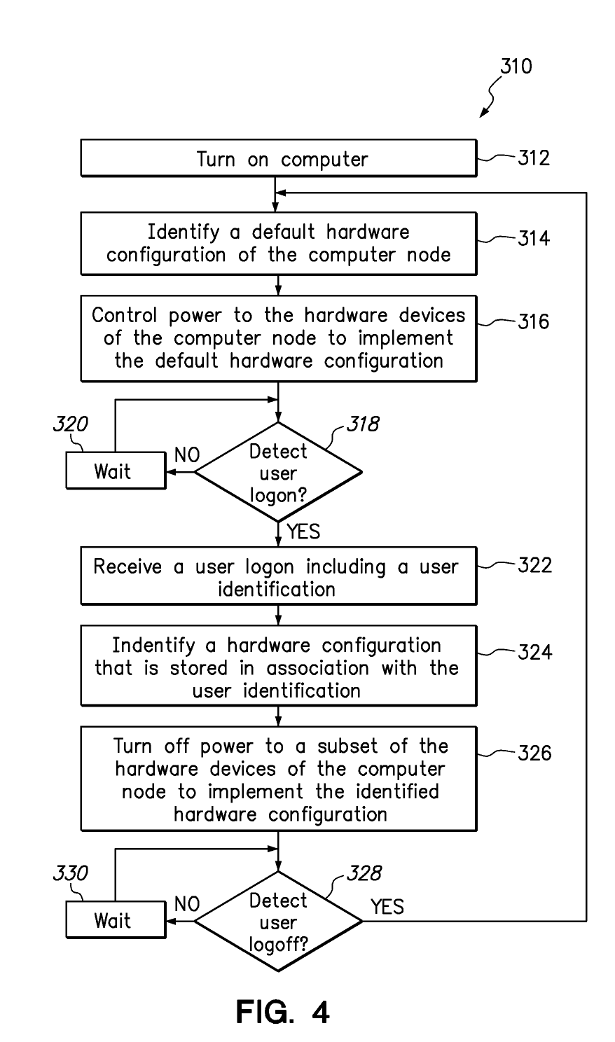

FIG. 4 is a flowchart of a second embodiment of a method 310 for configuring the hardware devices of a computer node. This embodiment includes the use of a default hardware configuration. The computer is turned on in step 312, a default hardware configuration of the computer node is identified in step 314, and power to the hardware devices of the computer node is controlled in step 316 to implement the default hardware configuration. If no user logon is detected in step 318, then the process waits in step 320. Essentially, the default hardware configuration is maintained until a user logon is detected in step 318.

In response to a user logon being detected in step 318, a user logon including a user identification is received in step 322. In step 324, the method identifies a hardware configuration that is stored in association with the user identification. The power is then turned off to a subset of the hardware devices of the computer node in order to implement the identified hardware configuration in step 326.

If no user logoff is detected in step 328, then the process waits in step 330. Essentially, the hardware configuration for the particular user that is presently logged on is maintained until a user logoff is detected in step 328. In response to detecting the user logoff in step 328, the process returns to steps 314/316 to identify and implement the default hardware configuration.

The foregoing computer nodes, methods and computer program products may be convenient in a computer laboratory or testing environment. Accordingly, a computer node may be modified to implement a particular hardware configuration without the need to power off the computer node, and then add and/or remove one or more devices, such as a DIMM, CPU, I/O device, and other cards/devices. For example, multiple users may be able to use the same computer node as their “device under test.” Furthermore, the present methods may be used to duplicate the configuration of another system. In another embodiment, the computer nodes and methods of the present invention may be used so that a fully populated computer node is operated, but a user is charged for use of the computer node based on the hardware configuration that is used.

It should be recognized that embodiments of the present invention conserve energy by powering off hardware devices that are not included in a particular hardware configuration. This is unlike virtual systems where all of the devices in a computer node are powered on regardless of use.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “preferably,” “preferred,” “prefer,” “optionally,” “may,” and similar terms are used to indicate that an item, condition or step being referred to is an optional (not required) feature of the invention.

The corresponding structures, materials, acts, and equivalents of all means or steps plus function elements in the claims below are intended to include any structure, material, or act for performing the function in combination with other claimed elements as specifically claimed. The description of the present invention has been presented for purposes of illustration and description, but it not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method of configuring the hardware devices of a computer node, comprising:
the computer node receiving a user identification;
identifying a hardware configuration of the computer node that is stored in association with the user identification, wherein the hardware configuration identifies a subset of the hardware devices that are to receive power; and
controlling power to the hardware devices of the computer node to implement the identified configuration of the computer node without physically removing the subset of hardware devices, wherein power is provided to the computer node except for the subset of the hardware devices.

2. The method of claim 1, further comprising:
storing the configuration of the computer node in associated with the user identification.

3. The method of claim 2, wherein the hardware configuration of the computer node is stored in nonvolatile memory.

4. The method of claim 1, wherein the one or more devices includes one or more central processor units.

5. The method of claim 4, further comprising:
allowing failover of one or more central processor units that were powered on to one or more central processor units that have been powered off.

6. The method of claim 1, further comprising:
controlling the speed configuration on one or more buses within the computer node.

7. The method of claim 6, wherein the one or more buses includes a direct media interface bus.

8. The method of claim 1, further comprising:
selectively enabling or disabling one or more slots that support an input/output device within the computer node.

9. The method of claim 1, wherein the one or more devices includes one or more memory devices selected from individual memory modules, memory controllers, or a combination thereof.

10. The method of claim 1, further comprising:
preventing one or more memory device or PCI device from being powered on during initialization of the computer node to allow the setup to complete in less time; and
powering on an additional memory device or PCI device after the setup has completed.

11. The method of claim 10, wherein preventing one or more memory device or PCI device from being powered on during initialization of the computer node includes holding one or more PCI device in reset.

12. The method of claim 1, wherein the power to one or more of the particular devices is powered off using a switch to interrupt the supply of power to the one or more of the particular devices, wherein the switch is controlled by the FPGA.

13. The method of claim 1, wherein the computer node receives the user identification during user logon to the computer node.

14. The method of claim 13, further comprising:
storing a description of a default hardware configuration of the computer node; and
returning the computer node to the default hardware configuration in response to user logoff from the computer node.

15. The method of claim 14, wherein controlling power to particular devices within the computer node to implement the identified hardware configuration of the computer node comprises:
using a field-programmable gate array to control power to each of the particular devices.

16. The method of claim 14, wherein an integrated management module within the computer node receives the user identification and identifies a hardware configuration of the computer node associated with the user identification.

17. The method of claim 16, wherein the integrated management module has memory that stores the user identification and the associated hardware configuration.

18. A computer program product including computer usable program code embodied on a computer usable storage medium for configuring the hardware devices of a computer node, the computer program product including:
computer usable program code for storing a hardware configuration of the computer node in associated with a user identification;
computer usable program code for receiving a user identification during user logon;
computer usable program code for identifying a hardware configuration of the computer node that is stored in association with the user identification, wherein the hardware configuration identifies a subset of the hardware devices that are to receive power; and
computer usable program code for controlling power to the hardware devices of the computer node to implement the identified configuration of the computer node without physically removing the subset of hardware devices, wherein power is provided to the computer node except for the subset of the hardware devices.

19. The computer program product of claim 18, further comprising:
computer usable program code for preventing one or more memory device or PCI device from being powered on during initialization of the computer node to allow the setup to complete in less time; and
computer usable program code for powering on an additional memory device or PCI device after the setup has completed.

20. The method computer program product of claim 18, further comprising:
computer usable program code for storing a description of a default hardware configuration of the computer node; and
computer usable program code for returning the computer node to the default hardware configuration in response to user logoff from the computer node.
